(19) United States
(12) Patent Application Publication
(10) Pub. No.: US 2007/0074513 A1
(43) Pub. Date: Apr. 5, 2007

(54) TURBO CHARGING IN A VARIABLE DISPLACEMENT ENGINE

(76) Inventors: William Lamb, North Cowton (GB); Ian Pegg, Chelmsford (GB); Michael Watts, Saffron Walden (GB)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/535,100

(22) Filed: Sep. 26, 2006

(30) Foreign Application Priority Data
Oct. 3, 2005 (GB) 0519935.1

(51) Int. Cl. F02B 33/44

(52) U.S. Cl. 60/612; 60/605.1

(57) ABSTRACT

A variable displacement internal combustion engine having selectively disabled cylinders, the engine including two turbochargers each having a turbine and a compressor, an exhaust system connecting the turbines of both turbochargers to all the engine cylinders, and valving within the exhaust system for selectively directing exhaust gases to flow through one, the other or both turbocharger exhaust turbines, the valving being controlled in dependence upon the number of deactivated cylinders.

### FIELD OF THE INVENTION

This invention relates to variable displacement engines, and more particularly to applications involving turbo charging to improve power.

### BACKGROUND AND SUMMARY OF THE INVENTION

Recent advances in engine development have lead to the production of variable displacement engines or VDEs VDEs are internal combustion engines having the ability to selectively disable cylinders when power output does not demand use of the full engine. This creates a smaller capacity of working engine hence the term variable displacement engine.

The concept of VDE may be employed in both spark and compression ignition engines and leads to increased fuel economy predominantly when the vehicle is cruising, such as on motorways. Depending on the torque requirement and the hardware available, many different configurations of cylinders can be run. For example, four, six, eight, ten and twelve cylinder engines with as many cylinders deactivated as is possible.

Many engines, especially diesels, employ a turbocharger to boost power output. This presents the problem that the size of the turbocharger, in terms of the volume of exhaust gases driving the turbine, the volume of air its compressor can pump and the pressure ratios at which it is most efficient is determined by the engine size. When any number of cylinders are deactivated, the chosen turbocharger is no longer ideal for the remaining effective capacity of the engine and so compromises performance results.

A solution proposed in U.S. Pat. No. 6,715,289 provides two turbochargers, each connected via its own exhaust manifold to half the available cylinders of a spark ignition variable displacement engine. In this engine, one group of half the total cylinders may be disabled and as a result, one turbocharger is selectively deactivated and its compressor outlet isolated from the outlet of the operating turbocharger compressor. In this set up, the combined output of both turbochargers is selected to be suitable for maximum load of the engine, but in a partially deactivated mode, one turbocharger is correctly chosen for half the full engine capacity.

Another prior art teaching provides a variable displacement diesel engine having a twin scroll turbocharger. A twin scroll turbocharger has two scrolls within one turbine wheel having different geometries from one another. In this case, the exhaust gases of the permanently enabled cylinders drive one scroll of the turbine and those of the cylinders which are selectively disabled drive the other scroll. The benefit of this arrangement is that when the engine is operating on a reduced number of cylinders connected to the appropriate turbine scroll, the turbocharger can still operate efficiently given the reduced gas flow through the turbine. When all the cylinders are enabled, an increased volume of exhaust gas drives the turbocharger through both turbine scrolls meaning that the turbocharger remains appropriately sized to supply air to all the cylinders.

The disadvantage of both these teachings is that the variable displacement facility is limited to the same cylinder group each time, which leads to unequal wear of the cylinders.

According to the present invention, there is provided a variable displacement internal combustion engine having selectively disabled cylinders, the engine having: two turbochargers each having a turbine and a compressor, an exhaust system connecting the turbines of both turbochargers to all the engine cylinders, and valving within the exhaust system for selectively directing exhaust gases to flow through one, the other or both turbochargers exhaust turbines, the valving being controlled in dependence upon the number of deactivated cylinders.

Preferably, the two turbochargers differ in flow output from one another.

Advantageously, at least one of the turbochargers has a twin scroll turbine.

In a preferred embodiment of the invention, the valving may additionally be controlled in dependence upon any one or more of demand pedal position, manifold pressure, rate of change of throttle position, vehicle speed, fuel consumption and engine speed.

The above advantages and other advantages, and features of the present invention will be readily apparent from the following detailed description of the preferred embodiments when taken in connection with the accompanying drawings, and from the claims.

### BRIEF DESCRIPTION OF THE DRAWINGS

In the following text, the invention will be described in detail with reference to the attached drawings. These drawings are used for illustration only and do not in any way limit the scope of the invention. In the drawings:

FIGS. 1, 2 and 3 show schematic representations of the engine intake, exhaust and turbocharger configuration during different variable displacement operating modes.

### DESCRIPTION OF PREFERRED EMBODIMENT(S)

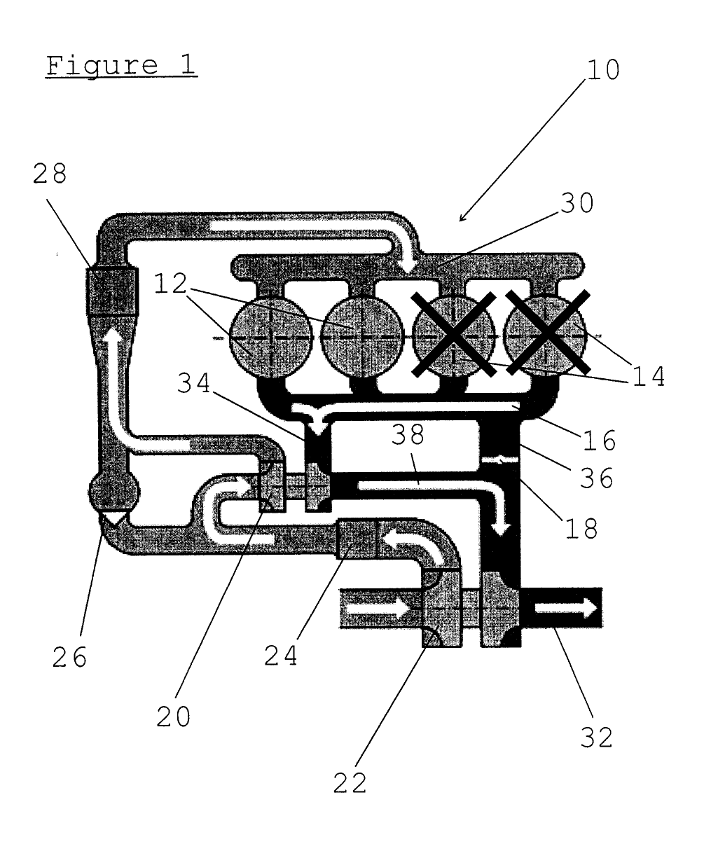

FIG. 1 shows a variable displacement engine 10 operating in a reduced displacement operating mode. In this mode two of the four cylinders remain active 12, whilst two others, designated 14, are disabled. When disabled the inlet and exhaust valves to the cylinder remain closed and make no contribution to the exhaust gases.

When operating with only two cylinders, the engine is more efficient, and thus is it preferable to run in this mode whenever possible.

In conventional turbo diesel engines, exhaust gases power the turbocharger, which compresses the air entering the cylinders. The more air and fuel that can be burned in the cylinder, the more power the engine can produce. However, when employing variable displacement technology, the exhaust gases from (in this example) only two cylinders is insufficient to operate the turbocharger in its useful s efficiency range as its size would normally have been chosen for use with all the engine's available cylinders.

FIG. 1 shows a preferred embodiment of the present invention in which two turbochargers 20 and 22 of different sizes are connected by way of respective parallel branches 34 and 36 to an exhaust manifold 16 common to all the engine cylinders. Branch 36 contains a butterfly valve 18, which serves to restrict flow along the branch 36 progressively between unrestricted and completely restricted positions.

The exhaust output of the turbocharger 20 is connected by way of a cross pipe 38 to the branch 36, downstream of the butterfly valve 18 and upstream of the turbocharger 22. FIG. 1 shows the butterfly valve 18 in its fully closed position, preventing exhaust gas from flowing directly to the turbine of turbocharger 22. In this position, all the exhaust gases from the active cylinders will flow through the turbine of the smaller turbocharger 20. Due to its smaller size, turbocharger 20 is capable of generating sufficient compressed air for the active cylinders with only the reduced exhaust gases they supply.

The exhaust from turbocharger 20 then flows along the cross pipe 38 through the turbine of turbocharger 22. There is not sufficient gas to allow turbocharger 22 to compress much air, the gas there just serves to keep the shaft of the turbocharger spinning in preparation for when it is used to generate useful boost. It is possible to activate a wastegate (not shown) coupled to turbocharger 22 in order to reduce the back pressure in the exhaust.

Air enters the intake system of the engine at the input to the compressor of turbocharger 22. When the turbocharger 22 is idling as described above the intake air merely exits the compressor at the same pressure at which it entered. To reduce the flow restriction, a valve (not shown) may be used to bypass the compressor when the turbocharger 22 is not providing any compression.

Air from the compressor of turbocharger 22 then enters an intercooler 24, though it will not have been substantially heated since no compression will have occurred at this stage. The air then flows through the compressor of turbocharger 20 and through intercooler 28 before entering the inlet manifold 30. The air is prevented from bypassing the compressor of turbocharger 20 by a closed non-return valve 26. The valve 26 is closed because the air downstream of the bypass valve is at a higher pressure than the air upstream coming from the compressor of turbocharger 22.

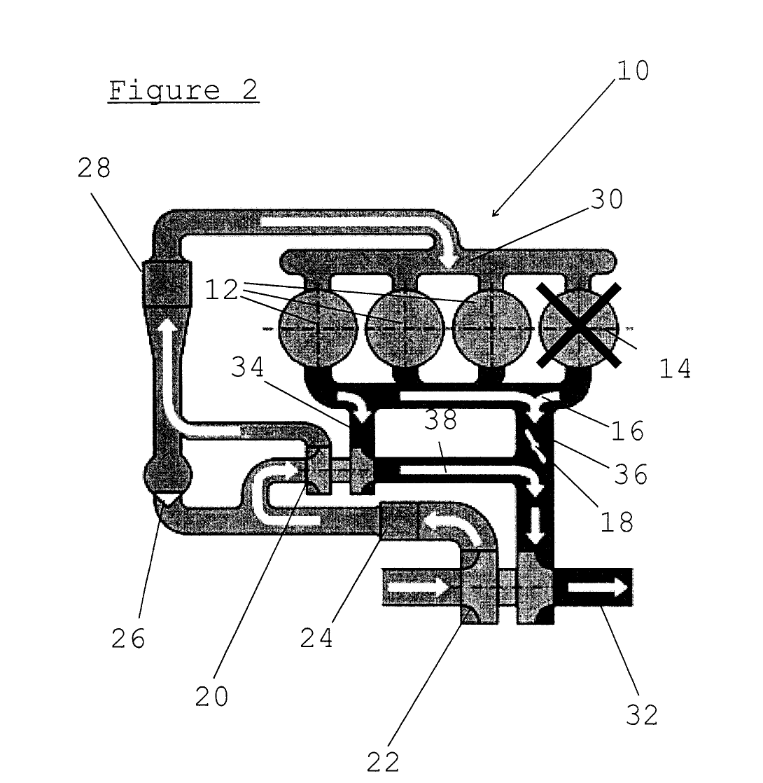

In FIG. 2, only one cylinder 14 is disabled and three cylinders 12 provide exhaust gases to exhaust manifold 16. In this case, the butterfly valve la is partially open to allow a fraction of exhaust gases to bypass the turbine of turbocharger 20 and to flow directly to the turbine of turbocharger 22. Since three cylinders 12 are now generating exhaust gases, there is enough energy in the exhaust gases to spool both turbochargers.

On the intake side, air entering the compressor of turbocharger 22 is compressed to a pressure higher than atmospheric and then cooled in intercooler 24. As previously described, it is then compressed further by turbocharger 20, which it is again prevented from bypassing by the non-return valve 26, which remains closed on account of the pressure differential across it.

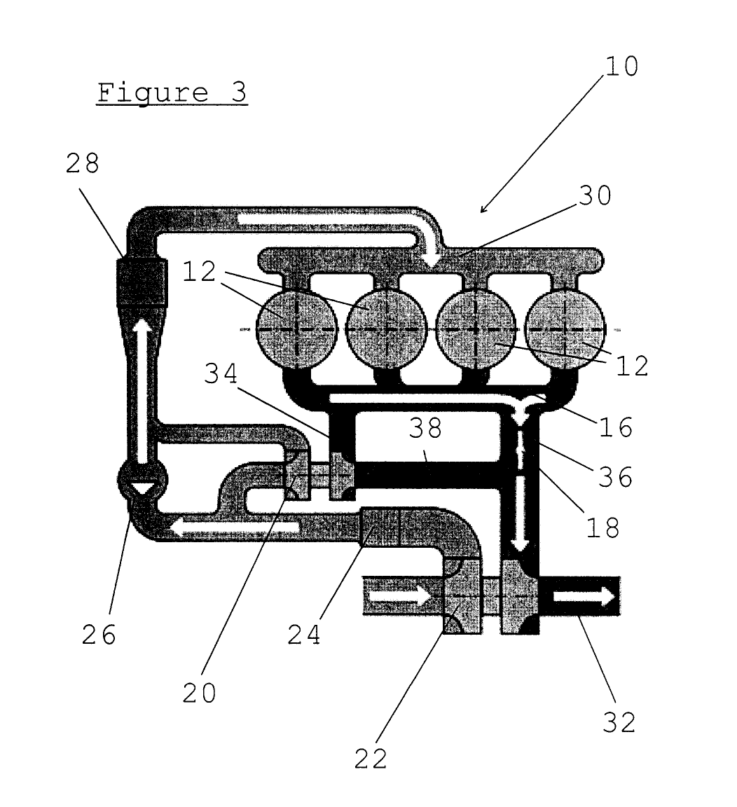

In FIG. 3, all the cylinders are enabled and the butterfly valve 18 is fully open. In this mode, most of the exhaust flows through the turbine of the larger turbocharger 22 as it represents a smaller restriction to the flow path.

On the intake side, much of the compression is done by turbocharger 22. As in the other two modes, the air is then cooled in intercooler 24, which may be an air/air or air/water heat exchanger. Since the gas flow rate through the turbine of turbocharger 20 is much reduced, it no longer has sufficient energy to compress air beyond the pressure to which it has already been compressed by turbocharger 22. As a result of this, the air downstream of bypass valve 26 is no longer at a higher pressure than the air exiting turbocharger 22. As a result, the bypass valve 26 opens to allow air to bypass the compressor of turbocharger 20. Air will then flow directly through intercooler 28 and into intake manifold 30 to supply all four enabled cylinders.

In the embodiment above, the turbochargers are of different sizes. Though advantageous, this is not essential as the invention would function in the same way if turbochargers of,equal size are used. The only difference is that the opening degree of the butterfly valve 18 is altered in order to provide the appropriate amount of turbo charging across both turbochargers. At the open position of butterfly valve 18, both turbochargers contribute equally to the compression of the air as the pressure drop across their turbines will be substantially the same. The invention therefore serves to control the degree of disablement of a turbocharger in response to the number of active cylinders in a variable displacement engine.

When operating with two identical turbochargers, it may be further beneficial to provide a bypass valve to enable air to avoid the flow restriction created by the compressor of turbocharger 22 even though, when idling, this would not be too much of a restriction. This is because any flow restriction will alter the pressure ratio across the compressor wheel of turbocharger 20, and subsequent compression will amplify the effect of the restriction.

While the invention requires the butterfly valve 18 to be controlled in response to the number of active cylinders operating within the engine, this does not preclude it from being controlled additionally in dependence upon other operating parameters. The control of the valve may therefore also depend on throttle position, manifold pressure, rate of change of throttle position, vehicle speed, fuel consumption or engine speed. In this way, the appropriate turbocharger can be utilised in dependence upon the desired performance from the engine. The control is handled within the engine control unit (not shown), which is typically also responsible for valve disabling during variable displacement running.

For example, if the throttle position indicates that 40% of total engine power is required whilst the vehicle is cruising on a motorway using two of the four engine cylinders, it is more efficient to continue to utilise two cylinders to provide that power, than to reactivate all the cylinders of the engine.

In such a situation, the engine can run in any number of modes, for example, two, three or four cylinders and any degree of turbo charging. Armed with information such as the factors mentioned above, the engine control unit can decide the best method by which the engine can provide 40% power by predicting the likely intention of the vehicle operator. This may be because the rate of change of the throttle position indicates that the target of 40% is likely to be transitional prior to a higher target, in which case it would be beneficial to reinstate all the engine's cylinders.

Alternatively, if the vehicle speed is already high, the engine speed low (in a high gear), the history of throttle input suggests motorway cruising and the throttle position has been increased slightly in order to overtake a slower vehicle, the ECU would likely determine that the engine could remain in a two cylinder operating mode, and maintain a better fuel economy.

The invention is not limited to the embodiments described above and may be varied freely within the scope of the appended claims.

1. A variable displacement internal combustion engine having selectively disabled cylinders, the engine comprising:
two turbochargers each having a turbine and a compressor;
an exhaust system connecting the turbines of both turbochargers to all the engine cylinders; and
valving within the exhaust system for selectively directing exhaust gases to flow through one, the other or both turbocharger exhaust turbines, the valving being controlled in dependence upon the number of deactivated cylinders.

2. The variable displacement engine as claimed in claim 1, wherein the two turbochargers differ in flow output from one another.

3. The variable displacement engine as claimed in claim 2, wherein at least one of the turbochargers has a twin scroll turbine.

4. The variable displacement engine as claimed in claim 3, wherein the valving is also controlled in dependence upon any one or more of demand pedal position, manifold pressure, rate of change of throttle position, vehicle speed, fuel consumption and engine speed.
